(19) United States
(12) Patent Application Publication
(10) Pub. No.: US 2026/0042505 A1
(43) Pub. Date: Feb. 12, 2026

(54) ELECTRIC BICYCLE WITH CELLULAR ACCESS AND SAFETY FEATURES

(71) Applicant: ORBIC PR LLC, San Juan, PR (US)

(72) Inventor: Parveen Narula, Sands Point, NY (US)

(21) Appl. No.: 18/799,629

(22) Filed: Aug. 9, 2024

(51) Int. Cl. B62M 6/45; B62J 45/20

(52) U.S. Cl. CPC B62M 6/45; B62J 45/20

(57) ABSTRACT

An electric bicycle includes a frame, a battery mounted on the frame, a motor powered by the battery to move the electric bicycle and handlebars rotatably coupled to the frame to steer the electric bicycle. A display unit is mounted on the handlebars and is powered by the battery. The display unit includes a processor, a display coupled to the processor, memory coupled to the processor and a communications device including a modem coupled to the processor. The modem communicates a status of the electric bicycle to a cellular network.

### STATEMENT REGARDING PRIOR DISCLOSURES BY THE INVENTOR

The following disclosure is submitted under 35 U.S.C. § 102(b)(1)(A):
DISCLOSURE: Prototype disclosed by the inventor at Mobile World Congress (MWC) Conference, Barcelona, Spain on Feb. 26, 2024.

### BACKGROUND

The present invention generally relates to electric bicycles, and more particularly to electric bicycles having cellular access and safety features.

Electric bicycles or e-bikes provide an efficient and economical method of transportation. E-bikes are relatively light and employ battery power. This makes them environmentally friendly and capable of use for any age range. However, e-bikes are highly maneuverable and can attain fast speeds making their use in busy areas possible but challenging.

A need exists for an e-bike which is aware of its surroundings and can improve safety for its driver and others in its vicinity.

### SUMMARY

In accordance with an embodiment of the present invention, an electric bicycle includes a frame, a battery mounted on the frame, a motor powered by the battery to move the electric bicycle and handlebars rotatably coupled to the frame to steer the electric bicycle. A display unit is mounted on the handlebars and is powered by the battery. The display unit includes a processor, a display coupled to the processor, memory coupled to the processor and a communications device including a modem coupled to the processor. The modem communicates a status of the electric bicycle to a cellular network.

An electric bicycle includes a frame, a battery mounted on the frame, a motor powered by the battery to move the electric bicycle, handlebars rotatably coupled to the frame to steer the electric bicycle and a display unit mounted on the handlebars and powered by the battery. The display unit includes a processor, a display coupled to the processor, memory coupled to the processor and a helmet application communicating with a helmet module to determine a status of a helmet being worn by a user.

In other embodiments, the display unit includes a main control unit that automatically disables a function of the electric bicycle in accordance with violation of a stored permission. The function can include a measured speed of the electric bicycle and the stored permission includes exceeding a speed threshold; a measured distance of the electric bicycle and the stored permission includes exceeding a distance threshold; a measured boundary of the electric bicycle and the stored permission includes exceeding a boundary threshold and/or other functions. The main control unit can disable the battery. The main control unit can message a remote person to provide a warning of a violation of permissions. A radar can be mounted on the frame to warn of approaching objects. A helmet can include a sensor to determine a helmet worn status indicating whether the user is wearing a helmet and a communications device can be included to transit the status to the display unit. The electric bicycle can include a camera mounted on the display unit and an application for face recognition to identify a helmet on the user. The electric bicycle can further include a communications device including a modem coupled to the processor, the modem to communicate a helmet worn status to a cellular network. The electric bicycle can include a mechanism to disable a function of the electric bicycle if the user lacks permission in accordance with an application for face recognition that identifies the user. One or more cameras can be integrated in or on the electric bicycle to capture images of approaching objects. An application to identify the approaching objects can be included.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is perspective view of an electric bicycle, in accordance with an embodiment of the present invention;

FIG. 2 is a block/flow diagram showing a schematic of a display unit for the electric bicycle, in accordance with an embodiment of the present invention.

FIG. 3 is a block/flow diagram showing a schematic of an electrical system of the electric bicycle, in accordance with an embodiment of the present invention;

FIG. 4 is a rear view of the electric bicycle showing a rear camera and a radar, in accordance with an embodiment of the present invention;

FIG. 5 is a block/flow diagram showing a schematic of a radar for the electric bicycle, in accordance with an embodiment of the present invention; and

FIG. 6 is a block/flow diagram showing a schematic of a helmet status checking system for the electric bicycle, in accordance with an embodiment of the present invention.

### DETAILED DESCRIPTION

In accordance with embodiments of the present invention, e-bikes and methods for employing e-bikes are described. In an embodiment, an e-bike includes cellular technology including a cellular antenna. In such embodiments, the e-bike integrate the cellular technology within the e-bike itself. The e-bike is its own cellular equipment user meaning that the e-bike does not rely on a user's cellphone to access the cellular network. The e-bike includes a display unit. The display unit includes interaction capabilities including a graphical user interface to program systems of the e-bike, record video, display camera images, interface with loaded software programs, among other things.

In an embodiment, the e-bike includes a mobile device management (MDM) platform including both hardware and software components for interfacing with a mobile network, (e.g., a 5G or other network). The MDM platform permits the e-bike to communicate with service systems, such as e.g., cloud systems and services. In one embodiment, the e-bike can employ eSIM technology to permit activation of a cellular plan from a carrier without having to use a physical SIM chip. The MDM platform can provide storage or computing resources for functions and/or features of the e-bike in accordance with present embodiments. For example, auto-registration of an e-bike can be performed over, e.g., eSIM. Other functions or features can include, e.g., downloading applications, activation/enablement of e-bike functions and/or capabilities, data usage monitoring, Cloud storage subscriptions, etc. In one embodiment, an Advanced Driver Assistance System (ADAS) program can be employed for rider safety that can be stored on the e-bike or accessed from the cloud. In another embodiment, an artificial intelligence (AI) application can be employed to keep track of trip details and provide timely tips to a driver as alerts on the display unit. AI applications can be customized for e-bike applications or can be accessed from the Cloud or other services.

Cellular connectivity on the e-bike in accordance with embodiments of the present invention can facilitate video recording, provide position or route tracking, permit video calls, stream music or video, provide global position system (GPS) navigation, implement alarms or notifications, permit Cloud uploads, provide fall detect notifications to others, provide hotspot connection for up to 30 other users, etc. Cellular connectivity on the e-bike in accordance with embodiments of the present invention can access mobile services via the touch screen on the display unit. This can also include any MDM controls. Cellular connectivity can also be employed to remotely locate the bike, track the bike for parental control, e.g., speed and geo fencing alerts, breakdown alerts and/or permit complete bike shut down as a result of theft or other conditions.

A main control unit of the e-bike in accordance with embodiments of the present invention can interact with a motor to, e.g., record speed, monitor battery power and collect diagnostic information. The main control unit can interact with a plurality of cameras mounted on the e-bike. Any number of camaras can be employed. In one example, a front camera is employed to record scenery. A display unit camera can be employed for video calling. A rear camera can be employed for the ADAS system to warn the rider that cars or objects are approaching from behind. Other camera positions and numbers are also contemplated. Adaptive riding assistance applications of the e-bike can be provided to navigate, e.g., routes with the least battery usage, elapsed time, etc. AI optimizations can be employed to determine a best route. The cameras can assist in the adaptive riding assistance applications to provide visual cues on the display unit of paths or directions to take to navigate, e.g., routes with the least battery usage, elapsed time, etc. The main control unit can provide predictive maintenance alerts to minimize operational downtime and to ensure the e-bike is running well.

In an embodiment, a helmet monitoring application can be employed. Depending on settings, in one example, the e-bike will not move unless a helmet is worn while on the e-bike. This can be achieved by measuring power properties using Bluetooth™ (BT) or radio frequency identification (RFID) proximity of the helmet to the e-bike, with helmet sensors and/or face recognition to ensure the helmet is worn, rather than attached to the e-bike.

In accordance with other embodiments, battery optimization algorithms (applications) can be employed to increase e-bike travel range and the life of the battery. The optimization algorithms can also be employed in planning a trip to determine projected battery usage over a given route. Tire pressure can be monitored using wireless tire pressure gauges. Tire pressure can be adjusted manually or automatically controlled by the main control unit (with wirelessly controlled pumps) to monitor and adjust pressure (using e.g., an on-board air pump) to an optimal level based on, e.g., riding conditions. Lower pressure can increase traction and reduce power loss. Suspension settings can also be controlled manually or using the main control unit to adjust the suspension (using e.g., the on-board air pump) in accordance with riding conditions or user preference. A locked-out suspension can reduce comfort and increase energy consumption over obstacles.

Battery optimization for pedal-assist mode can include an application that provides warnings or actual control of the pedal-assist function. For example, a lowest necessary level of pedal-assist can be determined and selected for optimizations. Higher modes consume more battery power. This can be performed by, e.g., cassette size adjustments. A larger cassette setting can help maintain an efficient cadence, which optimizes motor efficiency. E-bike cassettes include a series of gears on a rear wheel of an e-bike that permit for different speeds while riding. The cassette is mounted on a freehub, which is a ratcheting cylinder that connects to a wheel hub, and is held in place by a detachable lockring.

Battery optimization can include battery care as well. The main control unit can provide warnings on the display unit of the e-bike. Feedback from the battery to the main control unit can be employed to perform warning functions (e.g., also on direction from the MDM platform) as to whether maintenance is needed or driving conditions should be adjusted based on usage and data collected from the battery.

In an embodiment, onboard cameras and other sensing systems can be employed with the main control unit having ADAS features. An ADAS vision subsystem can identify vehicles, pedestrians, and lane lines ahead in real-time and detect the distance, orientation and relative speed between the e-bike and the vehicle in front or pedestrians, as well as detect the e-bike's position in a driving lane. Early warning judgments can be made to provide assistance for safe riding. In an embodiment, AI capabilities can be employed for functions such as, collision alarm (compute velocity and predict collision using depth sensing optical and radar mechanisms; lane departure warnings (use pattern recognition algorithms to produce early warnings); pedestrian collision warning (detect objects using local AI pattern classifications); rear approaching vehicle warnings (detect object proximity and collision impact warning); detection of vehicles and/or people moving faster towards the e-bike; traffic sign and rule enforcement alerts (include optical character recognition (OCR) mechanisms that read road signs and issue early warning alerts to the e-bike rider; blind spot detection alarms (detect objects and people present in blind spots). Other functions are also contemplated.

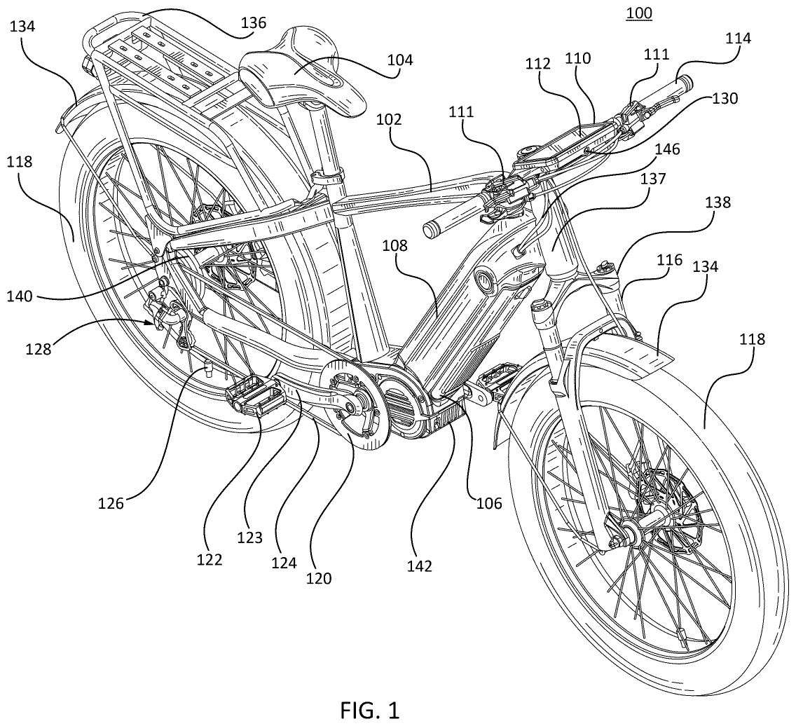

Referring now to the drawings in which like numerals represent the same or similar elements and initially to FIG. 1, a perspective view of an e-bike 100 is shown in accordance with an embodiment of the present invention. The e-bike 100 includes a frame 102, which can include a metal, such as steel, aluminum, a metal alloy, polymeric materials, a composite material, e.g., graphite, or any other suitable structural material. The frame 102 can be painted or otherwise colored and textured as appropriate. The frame 102 supports other components of the e-bike 100. A motor housing 106 is mounted to the frame 102 and includes a motor 142 for driving the e-bike 100. A battery housing 108 houses one or more batteries to supply power to the motor 142.

The frame 102 includes a steering bearing 137, which is coupled to a forked component 138 on one end portion and to handlebars 114 on an opposite end portion to permit steering of the e-bike 100. A suspension system 116 includes a suspension system 116 that can include shock absorbers and biasing devices (e.g., springs and/or pressurized pneumatic cylinders). The e-bike 100 includes wheels 118, which can number two or more (e.g. three, four, etc.) in some embodiments. Mud flaps or fenders 134 can be employed over the wheels 118 to prevent splashing or road debris from being directed at a rider.

The frame 102 includes a position for supporting a seat 104. The frame 102 connects to a back platform 136 that can permit luggage, packages or other items to be transported.

In addition to battery power, the e-bike 100 can be manually pedaled using pedals 122 and pedal crank arms 123. The pedal crank arms 123 engage with a pedal sprocket 120. The motor 142 in the motor housing 106 also engages with the pedal sprocket 120 so that the e-bike 100 can be powered by either mode. The pedal sprocket 120 drives a chain 124 to turn gears of a cassette 140 to drive the wheel 118 in a rear portion of the e-bike 100. A derailleur 128 can be employed to change gears in accordance with a manual or automatic command from the e-bike 100. Controls 111 mounted on the handlebars 114 can include directional signal controls, gear shifts, ignition and other devices (e.g., a horn).

In accordance with embodiments of the present invention, a display unit 110 is mounted on the handlebars 114 of the e-bike 100. The display unit 110 includes a display screen 112, which can include a liquid crystal display (LCD) or any other display technology. The display unit 110 is mounted at an angle to permit viewing by a rider during operation of the e-bike 100. In some embodiments, the position and angle of the display unit 110 can be adjusted by a user in accordance with their preference. The display unit 110 can include computer capabilities and can include an operating system and controls for implementing a plurality of functions on the e-bike 100. The display unit 110 can preferably include a 7 inch or higher display unit, with custom applications (e.g. application programming interfaces (APIs)), which can permit access to a mobile device management (MDM) platform to operate functions of the e-bike 100, such as, e.g., remote tracking, parental control to limit range and speed, geo fencing to limit position and distance, etc. The display unit 110 can execute smartphone apps or provide a web interface using cellular technology that can include integrated 3G, 4G, 5G or other cellular connectivity.

The display unit 110 is powered using battery power of the e-bike 100. The display unit 110 can include a power module or power card (not shown) for distributing power and signal to the various systems of the e-bike 100. Wires 146 can include power or signal leads that connect through the battery housing 108 to access battery power and to connect to sensors, motors, servos or other devices needing power that may be employed in various parts of the e-bike 100. The display unit 110 can include sensors integrated therein as well. For example, a front facing camera 130 can be integrated in the display unit 110 and wired or wirelessly connected within the display unit 110.

The display unit 110 interact with e-bike functions to manage and control aspects of the e-bike 100. The main control unit 302 can include hardware and software resources for storing and running applications 204. For example, in one application, battery optimization for pedal-assist mode includes warnings and updates or battery status or actual control of the pedal-assist function. For example, pedal-assist power consumption can be monitored and optimized. This can be performed by, e.g., cassette size adjustments where gears can be shifted to improve efficiency. Battery optimization can include battery care as well. The main control unit 302 can provide warnings on the display unit of the e-bike, e.g., “Regularly charge your battery and avoid extreme temperatures” or “Use the battery frequently to maintain its health”. Feedback from the battery to the main unit can be employed to perform warning functions (e.g., also on direction from the MDM platform) as to whether maintenance is needed or driving conditions should be adjusted based on usage and data collected from the battery. Data collected can include, e.g., loading data (from the suspension system) and a warning can include “Lighten your load where possible. Extra weight requires more energy”. Data collected can also include, e.g., speed data from wheels or GPS monitoring and a warning can include, e.g., “Maintain a consistent speed and avoid frequent stops and starts, which can drain the battery”. Other data collected can include, e.g., charging habits/strategy and a warning can include, e.g., “Charge the battery to about 80-90% for regular use to prolong its lifespan and avoid deep charges” or “Follow the 30-80 rule, keeping your battery charged between 30% and 80% most of the time”.

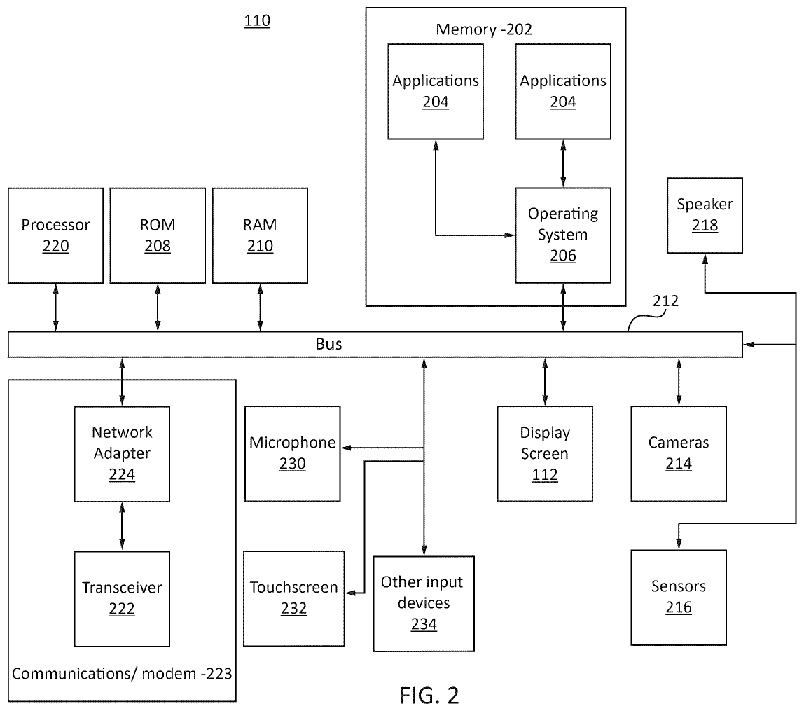

Referring to FIG. 2, the display unit 110 is schematically shown in accordance with an embodiment of the present invention. The display unit 110 includes at least one processor (e.g., a computer processing unit (CPU)) 220 operatively coupled to other components via a system bus 212. Storage memory or memory 202 can include an operating system 206 which is programmed to perform system functions for the display unit 110 and the e-bike 100. The memory 202 can include applications 204 or application programming interfaces (APIs) that run functions on the e-bike 100 or cooperate over a network through a transceiver 222 to communicate on device or off device with applications stored in the Cloud or other remote server. The memory can include Read Only Memory (ROM) 208 and a Random Access Memory (RAM) 210 as operational memory. The memory 202 can be any storage device (e.g., a magnetic, optical, electrical, etc.), e.g., a solid state magnetic device.

One or more input devices access the system bus 212 so that the display unit 110 can interface with a microphone 230, a touchscreen 232 or other input/output (I/O) device 234. The touchscreen 232 provide input functionality to a display screen 112. The input devices may be part of the display unit 110 (integrated) or may connect externally to the display unit 110.

A speaker or speakers 218 are operatively coupled to the system bus 212 to provide feedback sounds, alarms or output audio for streaming applications. A communication device 223 can include a modem, such as, e.g., a 5G modem. The communication device 223 includes a transceiver 222 that can be operatively coupled to the system bus 212 by a network adapter 224. The network adapter 224 can be employed to switch between networks or transmission modes to interact with one or more different networks or transmission protocols.

The other I/O device 234 can be any of a keyboard, a mouse, a keypad, an image capture device, a motion sensing device, a microphone, a device incorporating the functionality of at least two of the preceding devices, etc. Other types of input devices can also be used. Other inputs include input from cameras 214 and input from sensors 216 (e.g., tire pressure, load/weight pressure, radar, battery or motor data, etc.). Cameras 214 can be placed within or on the display unit 110 (e.g., a camera facing the rider, a front facing camera) or cameras can be mounted on different portions of the e-bike 100 (e.g., the rear of the e-bike 100).

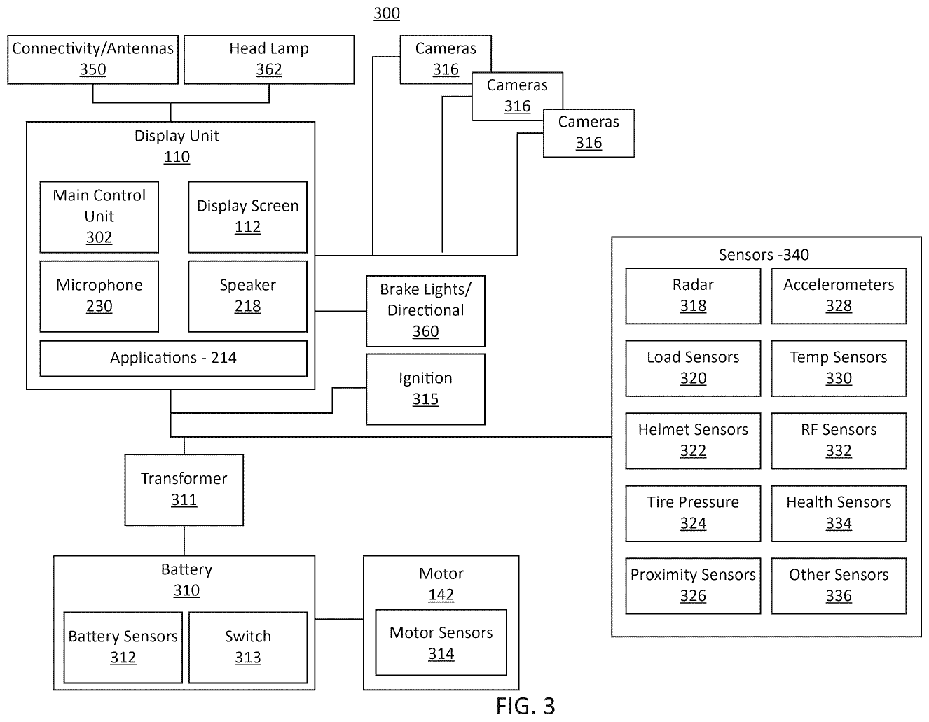

Sensors 216 (e.g., sensors 312, 314, sensor array 340 (FIG. 3)) can include tire pressure sensors, battery usage sensors, proximity sensors, helmet sensors, accelerometers, load pressure sensors, temperature sensors, RF sensors, radar antennae, RF antennae, health sensors, brake sensors, etc.

The display unit 110 may also include other elements (not shown) as well as omit certain elements. For example, various other input devices and/or output devices can be included in display unit 110, depending upon the particular implementation of the same. For example, various types of wireless and/or wired input and/or output devices can be employed. Moreover, additional processors, controllers, memories, and so forth, in various configurations can also be utilized as readily appreciated by one of ordinary skill in the art. These and other variations of the display unit 110 are contemplated given the teachings of the present invention.

The processor 220 can include a hardware processor. The hardware processor can include one or more semiconductor chips and can be or include a graphics processing chip. The processor 220 can include memory and run hardware and/or software elements in any combination to cooperate and perform one or more specific tasks. In useful embodiments, the hardware processor can include one or more data processing elements (e.g., logic circuits, processing circuits, instruction execution devices, etc.). The one or more data processing elements can be included in a central processing unit (CPU), a graphics processing unit (GPU), and/or a separate processor- or computing element-based controller (e.g., logic gates, etc.). The hardware processor can include one or more on-board memories (e.g., caches, dedicated memory arrays, read only memory, etc.). In some embodiments, the hardware processor can include one or more memories that can be on or off board or that can be dedicated for use by the hardware processor subsystem (e.g., ROM, RAM, basic input/output system (BIOS), etc.).

In some embodiments, the hardware processor can include and execute one or more software elements. The one or more software elements can include the operating system 206 and/or one or more applications 204 and/or specific code to achieve a specified result.

In other embodiments, the hardware processor can include dedicated, specialized circuitry that performs one or more electronic processing functions to achieve a specified result. Such circuitry can include one or more application-specific integrated circuits (ASICs), FPGAs, and/or PLAs. These and other variations of a hardware processor are also contemplated in accordance with embodiments of the present invention.

The applications 204 can be downloaded to the display unit 110 or can interact with servers or other devices over a network or networks. In one example, the display unit 110 can interface with the internet, WiFi®, local area networks, wide area networks, cellular networks or any other remote network. While wireless connection to a network is preferred, wired connection can be employed. For example, during battery charge, a wired connection to a home router or other equipment can be implemented. The applications 204 can include diagnostic applications (e.g., tire pressure check, battery efficiency results, load/weight measurements, etc.), safety control applications, battery optimization applications, navigation applications, ADAS applications, radar applications, video applications, face recognition, voice recognition, authenticity applications, fingerprint recognition, any MDM applications provided by a network service provider, etc. It should be understood that the applications should not be construed as limiting and that other applications are contemplated.

Referring to FIG. 3, a schematic diagram shows a high level implementation of an electrical system 300 of an e-bike in accordance with embodiments of the present invention. The electrical system 300 employs battery power from a rechargeable battery 310 or batteries. The battery 310 can include a recharging port (not shown) to connect to a charging station or home power to recharge the battery 310. In an embodiment, the battery 310 includes a 24 volt or a 48 volt DC battery. Other batteries are also contemplated. A transformer 311 can be included to ensure that the battery power delivered to the display unit 110 is appropriate (e.g., 12 volts DC). Other voltages may be employed.

The battery 310 powers the motor 142 when the motor 142 is engaged. The battery also powers a plurality of other systems including a sensor array 340 and cameras 316 and other e-bike functions. The display unit 110 can provide power and send and receive signals with appropriate signal types to each of the sensors in the sensor array 340, battery sensors 312, motor sensors 314 and peripherals integrated into the display unit 110 (e.g., camera 316, microphone 230, speakers 218, etc.). The sensors described should not be construed as limiting as other systems and sensors are contemplated.

The display unit 110 includes cellular connectivity hardware and software 350 including cellular antennae to directly interact with a cellular (or other) wireless network. The display unit 110 includes use interaction capabilities including a graphical user interface to enable phone calls, text messages, interact with programs, download apps, emails and any other programs for computers/cell phones. The display unit 110 includes a main control unit 302 that leverages the computing power of the display unit 110 to control e-bike systems and to add functionality to a user operating the e-bike. The main control unit 302 can provide a graphical user interface to enable a user to access diagnostics data, measure statuses using the sensor array 340 or other sensors (e.g., motor sensors 314, battery sensors 312, etc.). The main control unit 302 employs the hardware and software capabilities of the display unit 110 to control and manage the functions and features of the e-bike 100 and the interactions of the e-bike 100 with cellular or other networks.

In an embodiment, a rider could activate a video app to record video through the front camera 316 (see also FIG. 1, camera 130) during a trip. An image of a building at a destination address could be displayed on the display screen 112. A navigation app can be activated to show a preferred route. A status of a load sensor 320, tire pressure sensor 324, temperature sensor 330, etc. can be requested and its measurement displayed for the user. These and other sensors can be employed as feedback for a plurality of useful applications for the e-bike. For example, the battery sensors 312 can provide historical data for different routes and the energy expended over time. This data can be employed to map out the best route in terms of energy consumption. In other embodiments, motor sensors 314 can measure motor temperature or rotations as a way of gauging energy dissipation.

Health sensors 334 can be employed as wearable devices, e.g., a step counting watch, or at contact points (e.g., sensors on the handlebars 114 (FIG. 1)). Health sensors 334 can be employed to measure vital signs, e.g., heart rate, etc. This can be performed using a face recognition application to identify a condition of the rider. The health data can be for information purposes or for medical purposes.

Proximity sensors 326 can be employed to detect objects in close proximity to the e-bike 100. The proximity sensors can be mounted at any location on the e-bike 100. For example, the proximity sensors 326 can be mounted on the back platform 126 of the e-bike 100 to detect objects at the rear or in the blindspots of the e-bike 100. Accelerometers 328 can be mounted on the e-bike 100 to measure its position and/or orientation. The accelerometers 328 can also be employed to alert a remote user of a crash or fall of the rider. The accelerometers 328 and the proximity sensors 326 can work with one or more applications 204 to provide alerts, images or other responses through the main control unit 302 or through other peripherals (e.g. speaker, etc.). The accelerometers 328 can also be employed as a measure of fitness or a current state of health of a rider. Imbalance or erratic riding can be a flag to provide a warning message to the rider or others.

Other sensors 336 can include, e.g., brake sensors, which can indicate when the brake system 132 (e.g., hand brakes) is engaged. Other sensors 336 can include a brake monitoring sensor to monitor brake pad use and issue a warning when the brakes are too worn.

In an embodiment, remote monitoring can be enabled. The main control unit 302 can be configured with parental or guardian controls. The parental or guardian controls can be enabled to prevent use of the e-bike or to restrict use of the e-bike. By way of example, a hardware switch 313 can be employed with the battery 310 to disable or limit power to the motor 142. The hardware switch can include a chip or transistor device controlled by the main control unit 302 to enable or disable a power connection to the motor 142. This can be employed to prevent the user from violating the parental controls. In another example, a software switch can be employed as part of the main control unit 302 to prevent an ignition 315 from starting the motor 142. Combinations of hardware and software controls are also contemplated for implementing parental controls.

For example, parental controls can include remote programming by parents or others by accessing the main control unit 302 of the display unit 110 over the cell network. Access can be set up on a parent cell phone to program permission into the main control unit 302 of the e-bike and accessed through connectivity/antennas 350 to a network. The permissions can include distances, speeds, times of use, locations of use, identity of the rider, geofencing (e.g., distances and locations set together), etc. In an embodiment, a remote individual with protected access can log into the main control unit 302 from their computer or cell phone and enter permission information. Table 1 shows an example permissions table that can be employed to set parental or other permissions to limit usage of the e-bike 100.

TABLE 1
Example of permission setting

Permitted driver: “Mike” Distance from home: “1.2 miles” Maximum
speed: “25 mph”
Permitted time of use: “after 3PM until 6PM” Places to avoid: “ABC
Candy Store”
Weight limit: “170 pounds”
Geo fence: “Access map”

The display unit 110 can prevent access to change this data by the user so the parental controls override the user's activities. A password or other authenticity application can be employed to set up parental access to ensure that the user cannot change the permission settings. In an embodiment, a camera 316 on a same side of the display unit 110 and the display screen 112 (FIG. 1) can invoke a facial recognition app (e.g., application 204 or an application from, e.g., the Cloud) to make sure that “Mike” is the rider. A voice recognition app or fingerprint recognition app can also be employed to identify the user. During the use of the e-bike, a GPS/navigation app (e.g., application 204 or from, e.g., the Cloud) can be invoked or monitored to determine distance, locations and/or speed and test these values against the permissions. The time of use can be checked against a current time to determine if usage is within the permitted time window.

A soft key can be employed to open up a map feature to enable a “geo fence” to be drawn to limit an area of use of the e-bike. A boundary can be set by manually or automatically designating a region where use is permitted.

If permissions are exceeded a number of remedial actions may be taken. The remedial actions can include a warning flashing on the display screen 112, a sound/message over the speaker 218, a flashing light, screen or other indicator that a permission was exceeded. Another remedial action could be to disable the ignition 315, disable or limit battery power (using the switch 313 or soft control in the main control unit 302 to disconnect or limit battery power to reduce speed), disabling the motor 142 (permitting, e.g., only pedal power), calling a parent or other person, sending an alert to a parent or other person, etc. Other remedial actions can be taken and are contemplated as well as any combination of these and other remedial actions.

Permission can be applied to other sensors as well. For example, the load sensor 320 can be employed to indicate whether more than one rider is aboard or if the e-bike is overloaded. Weight can be measured from tire pressure sensors 324 or load sensors 320, which can employ pressure measurements in the tire or within a pneumatic cylinder (e.g., shock absorber). If weight is exceeded, remedial action can be taken, if needed. Remote alerts related to or unrelated to permissions can also be employed. For example, an alert can be sent to a remote parent or other person if tire pressure goes below a threshold (e.g. a flat tire). The alert can include a current position of the e-bike as well in case help should be sent. Alerts for excessive speed or other disabled states, etc. can also be sent with relevant information. Alerts can include text messages, emails, phone calls, screen images, audible sounds, etc. to a remote cell phone or computer screen.

Other applications can include a bread crumbing application (204 (FIG. 2)) where a route taken can be stored so you can ride a same path again or share the path with others to follow. The breadcrumb path can be sent as an alert should a disabled state or other state trigger a need for assistance. The breadcrumb path can be used to find a disabled e-bike or to track the e-bike in the event of theft.

Other electrical components are also included. For example, brake lights/directional signal lights 360 can be included. A headlamp 362 or lamps can be mounted on a front portion of the e-bike. In one embodiment, a light emitting diode (LED) bulb or bulb can be mounted into the display unit 110 or integrated within the display unit 110 opposite the display screen 112. The headlamp 362 can include soft controls to change the intensity and even the color of the LED bulb.

Other systems and components can also be included. The components set forth in FIG. 3 should not be construed as limiting; instead, other systems and components are contemplated and can be included (e.g., a horn, an on-board air pump, etc.)

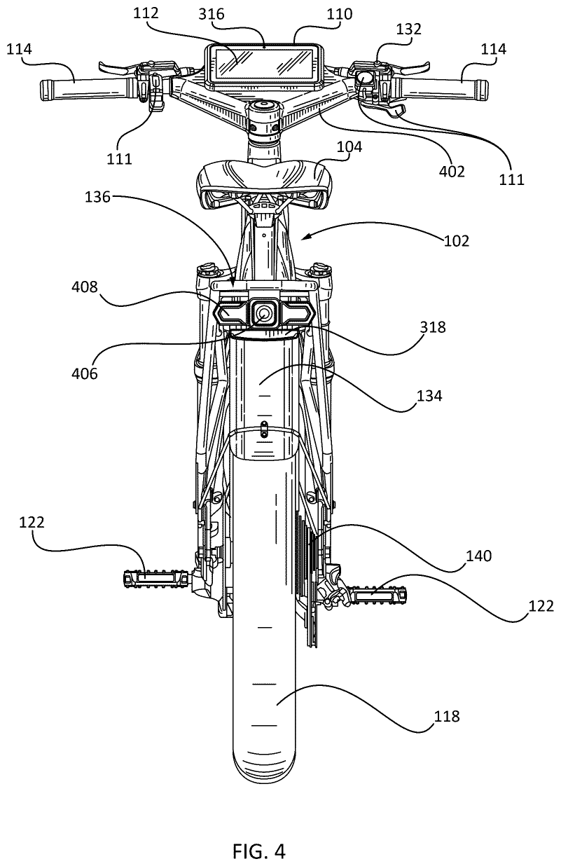

Referring to FIG. 4, a rear view of the e-bike 100 is shown in accordance with an embodiment of the present invention. The display unit 110 is mounted using a display mount or display frame 402 which includes a material (e.g., plastic) and structure to protect the display unit 110 from knocks, vibration, impact damage and weather, while not getting in the way of cables, e.g., brake cable of the brake system 132. The display frame 402 is built into the handlebars 114 with cable paths including sensor wires and power lines being fed through the frame 102 to reduce damage and ensure that the display unit 110 is sealed off from weather and other environmental hazards. The display unit 110 can be employed in all types of weather or environments. A nanocoating is deposited on the display unit 110 and display screen 112 to protect from water.

Integration of a rear camera 406 can be provided below the back platform 136 at the back portion of the e-bike 100. The rear camera 406 can be employed for object detection to alert the user of the impending object and to take action, if needed.

A radar 318 is mounted below the back platform 136 at the back portion of the e-bike 100. The radar 318 can also be employed for e-bike safety control to monitor approaching objects or vehicles. The radar 318 can include multiple components and antennas that could be employed for a number of tasks. The radar 318 can include a millimeter wave radar chip or chips. The radar 318 can be oriented to cover blindspots and be employed in blindspot detection. In other embodiments, the radar 318 can be pointed forward and used as a protection from forward collisions.

Unlike pulse radar that transmits a pulse periodically after every time delay, a continuous wave (CW) radar transmits continuously at a constant frequency.

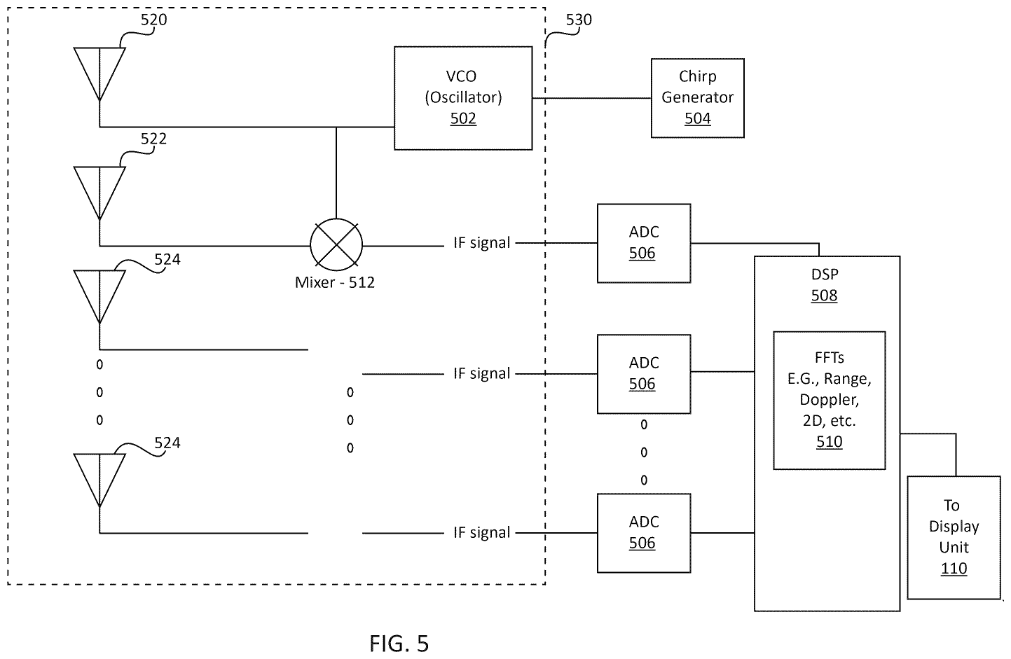

Referring to FIG. 5, a schematic diagram shows a circuit employed for the radar 318. In an embodiment, the radar 318 includes a frequency modulated continuous wave radar system. The radar 318 measures range instead of range rate (time interval between transmit tx and receiver rx) by frequency modulation, a systematic variation of the transmitted frequency. This puts a unique “time stamp” on the transmitted wave at every instant. By measuring the frequency of the return signal, the time delay between transmission and reception can be measured and therefore the range can be determined. The amount of frequency modulation needs to be significantly greater than expected Doppler shift to prevent negative impact on the results.

A transmitted wave generated from a transmit (tx) antenna 520 can be modulated using a voltage controlled oscillator (VCO) 502 to linearly increase the frequency. In other words, the transmitted frequency will change at a constant rate. A chirp is a signal that can be generated by a chirp generator 504 whose frequency increases linearly at constant rate. An inaudible chirp can include a frequency between about 10 MHz and 40 MHz between a time of 0 microsec to 2 microsec and repeated periodically.

The radar 318 can measure an instantaneous difference between the transmitted and received frequencies, □f. The received frequencies are received by a receive (rx) antenna 522. This difference is directly proportional to the time delay, □t, which is takes the radar signal to reach the target and return. From this the range, it can be found using the usual formula, R=c□t/2. The time delay can be found as follows: □t=T□f/(f₂−f₁) where: f₂=maximum frequency, f₁=minimum frequency, T=period of sweep from f₁ to f₂, and □f=the difference between transmitted and received.

Range resolution is the ability of the radar 318 to distinguish between two objects, which are moving closer to each other. At some point the radar 318 will not be able to distinguish between the objects as separate objects. At the receiver end, both the transmitted (tx) signal and the received signal (rx) are mixed by a mixer 512 to produce a new signal with a new frequency (intermediate frequency (IF) signal). The new frequency is the difference between the two input signals: the tx and rx signal. As an example, for signal x1 and x2: x1=sin(w1t+Q1); x2=sin(w2t+Q2); IF signal=sin((w1−w2)t+(Q1−Q2), where w and Q are angle and phase.

Fast Fourier Transforms (FFTs) 510 permit an increase in the resolution by increasing a length of the IF signal. To increase the IF signal the bandwidth of the chirp should also be increased proportionally. An increased length IF signal will have two separate peaks in an IF spectrum. The FFT 510 also provides that an observation window T can resolve frequency components that are separated by 1/T (HZ). This means that two IF signal tones can be resolved in frequency as long the frequency difference (Df) satisfies the relation Df=1/Tc, where Tc is an observation interval.

The range resolution only depends on the bandwidth swept by the chirp d (resolution)=c/2B if B=4 GHz d(rs)=3.75 cms and c is the speed of light. Once the IF signal is obtained from the mixer 512, it is digitized by an analog to digital converter (ADC), the IF signal is further processed on a digital signal processor (DSP) 508.

IF bandwidth is thus limited by the ADC sampling rate(s). The bandwidth of interest of the IF signal depends on desired maximum distance fmax=(S*2*dmax)/c. An ADC sampling rate of Fs limits the maximum range of the radar to dmax=(Fs*c)/2*S, where S is the slope of the transmitted chirp.

The radar 318 includes generates transmitted (tx) signals and measures received (rx) signals. The processing of the radar signals can be performed in the display unit 110 and can be programmed into a radar app in the main control unit 302. The radar app can include DSP and ADC functions and perform computations to resolve objects and distance to the objects. In one embodiment, a synthesizer generates a chirp at the chirp generator 504, which can be part of the radar app. A delayed version (rx) of the chirp is received by a receiver antenna after reflected by an object. The received signal (delayed version) is mixed with the tx signal by the mixer 512 and a signal of constant frequency is obtained (IF signal) for each object. This signal has multiple tones (constant IF signal) whose frequency is proportional to a distance to the corresponding object. The IF signal is digitized, the ADC supports an IF bandwidth of s*2*dmax/c. FFT 510 is performed on the ADC data. The location of peaks in the frequency spectrum directly correspond to the range of an object. The main unit 302 can distinguish peaks and can estimate a distance of an approaching object. If the object's speed or position exceed parameters a warning can be provided. The warning can include an image (of the rear camera) or signal on the display screen 112 of the display unit 110 (e.g., a flashing warning), a sound, a vibration (an unbalanced weight alarm in the seat 104), or any other alert or combination thereof.

A larger chirp bandwidth can result in better object resolution. Larger IF bandwidth can result is better maximum distance estimation (which is dependent on the sampling rate of the ADC). The transducer/synthesizer of the radar 318 is powered by the battery 310 and can be enabled or disabled using a switch or soft key in the main control unit 302 (FIG. 3).

Velocity estimation can also be performed using radar 318. A FFT can convert a time domain signal into a frequency domain signal. A sinusoid in the time domain produces a peak in the frequency domain. The signal in the frequency domain is complex where each value is a phasor of amplitude and a phase. Phase of the peak of a signal in frequency domain is equal to an initial phase of the sinusoid in the time domain. The phase of the IF signal is very sensitive to small changes in the object range (displacement of the object). An object at a certain distance produces an IF signal with a certain frequency and phase, small motions in the object changes the phase of the signal but not the frequency. For example, consider an object in a field of the radar signal moving with a velocity v. To measure the velocity of the object, the radar transmits two chirps separated by TC (delay between two consecutive chirps). A range-FFT corresponding to each chirp will have peaks in a same location but with different phases. Thus, by measuring the phase difference between two consecutive chirps, an estimate of the velocity of an object can be obtained.

Phase difference=4*pi*v*Tc/wavelength; then V=(wavelength*phase difference)/(4*pi*Tc), where v is the velocity of the object, Tc=delay between two consecutive chirps (end of the first chirp and the start of the next chirp). For unambiguous measures of velocity, phase difference should be less than <180 degrees, e.g., (4*pi*v*Tc/wavelength)<pi and v<(wavelength/4Tc), where Tc is the delay between two consecutive chirps. The maximum velocity that can be measured by two chirps spaced Tc apart is Vmax=wavelength/4Tc. Thus, higher Vmax requires closed spaced chirps.

The main unit 302 can distinguish peaks and can estimate a velocity of an approaching object. A warning can be provided, e.g., on the display screen 112. The warning can include an image (of the rear camera) or signal on the display screen 112 of the display unit 110 (e.g., a flashing warning), a sound, a vibration (an unbalanced weight alarm in the seat 104), or any other alert or combination thereof.

Velocity resolution of multiple objects may be needed as well. The ability of the radar 318 to distinguish two objects that are moving at different velocities at a same distance from the radar can be determined. If two chirps are needed to measure the velocity of an object, then to measure the velocity of multiple objects that are equidistance from the radar 318, a series of chirps can be transmitted which are equally spaced. This is called a chirp frame.

One FFT 510 can include a range-FFT can be applied on the reflected set of chirps resulting in a set of N identical peaks, but each with different phase incorporating the phase contribution from both these objects. Another FFT 510 can include a Doppler-FFT that can be performed on the sequence of phasors corresponding to range-FFT peaks which resolves the objects. Velocity resolution of the radar 318 is inversely proportional to the frame time. Tf=N*Tc where Tf is the frame time, N=number of chirps in a frame, Tc=difference between the start of second chirp to the end of the first chirp and Vres=wavelength/2*Tf.

In an embodiment, each frame including N chirps are transmitted by the tx antenna 520. At the rx antenna 522, the delayed versions of the chirps are processed by the ADC 506. The ADC data corresponding to chirps are stored as rows of a matrix. Similarly, each row corresponds to the consecutive frames. The range-FFT on each row resolves objects in range, and the doppler-FFT, along columns, resolves each column in velocity corresponding to each object's velocity. A minimum signal-to-noise ratio (SNR) is needed for detecting a target. A choice of SNR (min) is a trade-off between probability of missed detections and probability of false alarms.

The radar 318 can estimate an angle of reflected signal with a horizontal plane. This angle is called the angle of arrival (AO). Angular estimation is based on the observation that a small change in the distance of an object results in a phase change in a peak of the range-FFT or doppler-FFT. This result is used to perform angular estimation, using at least two rx antennas. The differential distance from the object to each other of the antennas results in a phase change in the FFT peak, the phase change enables estimation of the AOA.

Consider two objects equidistant from the radar 318 with a same velocity relative to radar. The range-velocity plot resulting from a 2D-FFT will have the same peak since the signals have a same range and velocity. One way to resolve this is to find AOA with the help of multiple antennas. A small change in the distance of the object results in a phase change in the peak of the range-FFT. Angle estimation employs at least two rx antennas (e.g., rx antenna 522 and rx antenna 524) the differential distance from the object to each of the antennas results in a phase change in the 2D-FFT peak which is exploited to estimate the angle of arrival. Measuring AOA of a target using 2 rx antennas can include transmitting from the tx antenna 520, a frame of chirps. A 2D-FFT corresponding to each rx antennas is computed, which will result in peaks in a same location but with different phases. The measured phase difference is used to estimate the angle of arrival.

$$Phase difference = 2 * pi * d * sin ( theta ) / wavelength .$$

$$AOA = sin - {}^{1} ( wavelength * phase difference ) / 2 * pi * d .$$

$$Pi = 3.1416 .$$

Angle estimation is more accurate at theta close to zero. Angle estimation degrades as theta approaches to 90° . . . . Angular field of view or maximum field of view can be serviced by two antennas spaced d apart as: theta₍ₘₐₓ₎=sin⁻¹(wavelength/2d) with a spacing d*wavelength/2 results in the largest field of view (+/−90°).

Measuring AoA of multiple objects at the same range and velocity can include an array of N receive antennas. An FFT on the sequence of phasors corresponding to 2D-FFT peaks resolves two objects. This is called angle-FFT. A minimum angle separation for two objects appears as separate peaks in the angle-FFT and is called angle resolution. Angle resolution: Theta₍ᵣₑₛ₎=2/N (assuming d=wavelength/2).

For range velocity angle resolution, range resolution is directly proportional to the bandwidth spanned by the chirp and a good synthesizer should be able to span a larger bandwidth, e.g., 4 GHz=3.75 cms. Velocity resolution (Vres) can be improved by increasing the frame time Tf, e.g., a T_{f} of 5 ms provides a Vres of 1.5 kmph. Increasing angle resolution includes increasing the number of rx antennas 524, each rx antenna has its own receive chain (mixer, low pass filter (LPF) (not shown) and ADC 506).

The radar 318 can include on-chip solutions with a small number of rx antenna chains. In one embodiment, the radar 318 include one or more chips 530 with multi chain cascading to increase the resolution (e.g., additional rx antennas 524).

A false alarm is an erroneous radar target detection decision caused by noise or other interfering signals exceeding the detection threshold. False alarm rate is the false detections of noise as targets. False alarms are generated when thermal noise exceeds a pre-set threshold level. If the threshold is set high, the targets which are far away may be lost. If the threshold is set too low, then there can be a lot of false targets.

Constant false alarm rate (CFAR) detection refers to a form of adaptive algorithm used in radar systems to detect target returns against a background of noise, clutter and interference and maintain a constant false alarm rate. The threshold is set variable: constant false-alarm rate where the threshold level is raised and lowered to maintain a constant probability of false alarms.

Cell-averaging CFAR can be employed. In CFAR detection schemes, the threshold level is calculated by estimating the level of the noise floor around the cell under test (CUT). This can be found by taking a block of cells around the CUT and calculating the average power level. To avoid corrupting this estimate with power from the CUT itself, cells immediately adjacent to the CUT are normally ignored (and referred to as “guard cells”). A target is declared present in the CUT if it is both greater than all its adjacent cells and greater than the local average power level. The estimate of the local power level may sometimes be increased slightly to allow for the limited sample size.

Other related approaches calculate separate averages for the cells to the left and right of the CUT, and then use the greatest-of or least-of these two power levels to define the local power level. These are referred to as greatest-of CFAR (GO-CFAR) and least-of CFAR (LO-CFAR) respectively, and can improve detection when immediately adjacent to areas of clutter. In an embodiment, a IWR6843 chip available from Texas Instruments™, which uses the CASO-CFAR (cell averaging smallest of CFAR) or (LO-CFAR) can be employed. The smallest of the left and right cell average is chosen to be compared with the CUT (cell under test) peak to determine if it is the target.

To provide safety features and to collect relevant information in a surrounding region, the e-bike can be equipped with sensors (e.g., proximity sensors 326, radar 318, cameras 316, etc.) to detect activity surrounding the e-bike. A point cloud is a set of data points in space that can be collected using cameras 316, radar 318, etc. The points represent a 3D shape or object. Each point has its set of X, Y and Z coordinates. Point clouds are generally produced by 3D scanners or by photogrammetry software, which measure many points on the external surfaces of objects around them. Reflection points reported in the point cloud are associated with existing tracking instances. Points that are not associated are subjects for the allocation decisions. Each candidate point is clustered into an allocation set. To join the set, each point needs to be within maxDistance Threshold (Thre) and max Vel Thre from the set's centroid. When the set is formed, it must have more than set PointsThre members, and pass the minimal velocity and SNRthreshold.

Allocations parameters include the following: SNR Threshold: Minimum total SNR for the allocation set; Points Threshold: Minimum number of points in the allocation set; Velocity threshold: Minimum radial velocity of the allocation set centroid; maxDistance Thre: Maximum squared distance between candidate and centroid to be part of the allocation set; max Vel Thre: Maximum velocity difference between candidate and centroid to be part of the allocation set.

Gating gain includes a gating parameters set, which is used in the association process to provide a boundary for the points that can be associated with a given track. These parameters are target specific. Gating parameters include: Gating Gain: The gating gain is a factor by which the gating volume can be increased to search for points to associate with the track (existing detected person); LengthLimit: Gating limit in length; WidthLimit: Gating limit in width; HeightLimit: Gating limit in height; VelocityLimit: Gating limit in velocity (e.g., 0—no limit).

The gating volume can be estimated as the volume of the ellipsoid, computed as, where a, b, and c are the expected target dimensions in range (m), angle (rad), and doppler (m/s). For example, consider a person as a radar target. For the target center, we could want to reach ±0.45 min length (a=0.9), ±3 degree in azimuth (b=6π/180), and ±5.18 m/s in radial velocity (c=10.36), resulting in a volume of approximately 4. In addition to setting the volume of the gating ellipsoid, the limit scan be imposed to protect the ellipsoid from over stretching. The limits are the function of the geometry and motion of the expected targets. For example, setting the Width Limit to 8 m does not allow the gating function to stretch beyond 8 m in width.

State transition parameters determine the state of a tracking instance. Any tracking instance can be in one of three states: FREE, DETECT, or ACTIVE. Instances in ACTIVE state produce tracks. Once per frame, each instance will get a hit (have one or more points associated with the instance), or a miss (have zero points associated with the instance).

A threshold for each state includes the following: 1) det2activeThre, in DETECT state how many consecutive HIT events needed to transition to ACTIVE state; 2) det2freeThre, in DETECT state, how many consecutive MISS events needed to transition to FREE state; 3) active2freeThre, in ACTIVE state and NORMAL condition how many consecutive MISS events are needed to transition to FREE; 4) statestatic2freeThre, in ACTIVE state and STATIC condition how many consecutive MISS events are needed to transition to FREE state; 5) FREEstateexit2freeThre, in ACTIVE state and EXIT condition how many consecutive MISS events needed to transition to FREE state; and 6) FREEstatesleep2freeThre, in ACTIVE state and sleep condition how many misses are needed to transition to FREE state.

Scenery parameters include a set of parameters to set background constraints. The scenery parameters define the space in which the point cloud is being captured, and need to be set in a graphical user interface (GUI), and chirp configuration for understanding of the point cloud. Scenery parameters can include, e.g., left wall, right wall, lower field, upper field, etc.

There are multiple parameters that affect the range at which a person can be positively identified and tracked. First, make sure you are using a chirp that extends to the range at which you want to detect people. Then consider changing these three parameters: Allocation Parameters-SNR Threshold; Allocation Parameters-Points Threshold; State Transition Parameters-Det2Active Threshold. At a distance, the reflected signal will be weaker. This will decrease the SNR of the target points, and potentially reduce the size of the point cloud. By lowering the Points threshold, fewer points are needed to allocate a track to the cluster. Lowering the SNR threshold will lower the cumulative SNR needed for an allocation set to be considered a track (target). Lowering these parameters increases the chance of false detection. Lowering the Det2Active Threshold will not improve an application's (204) ability to detect people. However, it will lower the amount of time for a detected person to enter ACTIVE tracking state. As a result, the track will appear farther away when a target is approaching.

When close together in some situations, one tracking application 204 can include a tracking application that can allocate one track for two or more people. This is likely to happen when the people are near each other, and walking at the same pace in the same direction. Other times, the tracker may give one person multiple tracks. To prevent these situations parameters such as Allocation—maxDistanceThre; Allocation—max VelThre; Gating—Volume; Gating—Length Limit; Gating—Width Limit and Gating—Velocity Limit can be adjusted. All of these parameters will affect how points in the point cloud get distributed into different tracks. Changing the thresholds under Allocation will affect how points in the point cloud are initially added to tracks. Lowering these thresholds will increase differentiation of clusters, while raising them will decrease differentiation.

Gating parameters are employed to associate points with tracks that already exist. By lowering these thresholds, points will have to be closer to a track to be counted as part of that track. Increasing these parameters will allow a track to take on points farther away. In situations where multiple people will be walking near each other, keeping these values low will make it easier for the tracking application 204 to separate their individual point clouds.

Parameters related to radar performance include MAXIMUM Range (Rmax=(Ifmax*c)/(2*S). IF max is Maximum IF bandwidth supported; c is the speed of light; S is the slope of the transmitted chirp. Another aspect that limits the radar range is the signal to noise ratio (SNR) of the received signal by the receiver. This depends on RF performance of the radar 318, like tx output power, rx noise, as well as chirp parameters like chirp duration and number of chirps in the frame. Antenna parameters like the tx and rx antenna gain in a direction of interest. Object characteristics like Radar Cross Section (RCS). RCS is a measure of the amount of energy the object reflects back. This decides how detectable the object is with a radar sensor. Minimum SNR needed by the detection algorithm to detect an object.

The radar 318 can be employed to associate and identify people or objects within a point cloud. Applications employed by the main control unit 302 can be employed to identify people or objects around the e-bike 100. Object detection can be employed in safety and security apps. For example, an application can employ a deciphered point cloud of a person. Once detected a camera 316 can be triggered to capture an image and a face recognition app can be employed to identify that person. This can be a theft deterrent or alert a parent that multiple riders are using the e-bike, among other uses.

The radar 318 can be used for a number of applications and can assist in many others. For example, the radar 318 can be employed to assist in a helmet detection application, in a facial ID application (e.g., to grant access to e-bike); a tracking application (e.g., to detection advancing objects and people), a health monitoring application (e.g., to monitoring health of a rider by detecting changes in the rider, etc.). The radar 318 can be employed for ADAS applications, such as, e.g., collision alarm (objects or pedestrians), lane departure warnings, rear approaching vehicle/object; traffic sign detection; blindspot detection, etc. These and other features can include artificial intelligence (AI) systems to assist in identifying objects. For example, traffic signs can be uploaded to an AI model to classify the road sign, object images can be uploaded to AI to identify the object; face images can be uploaded to AI to identify a person; etc. AI can be employed to trace out a best path using data collected by the display unit 110 of the e-bike 100. In other embodiments, these applications (e.g., ADAS) and features can be assisted by or replaced by camera-based image recognition and processing.

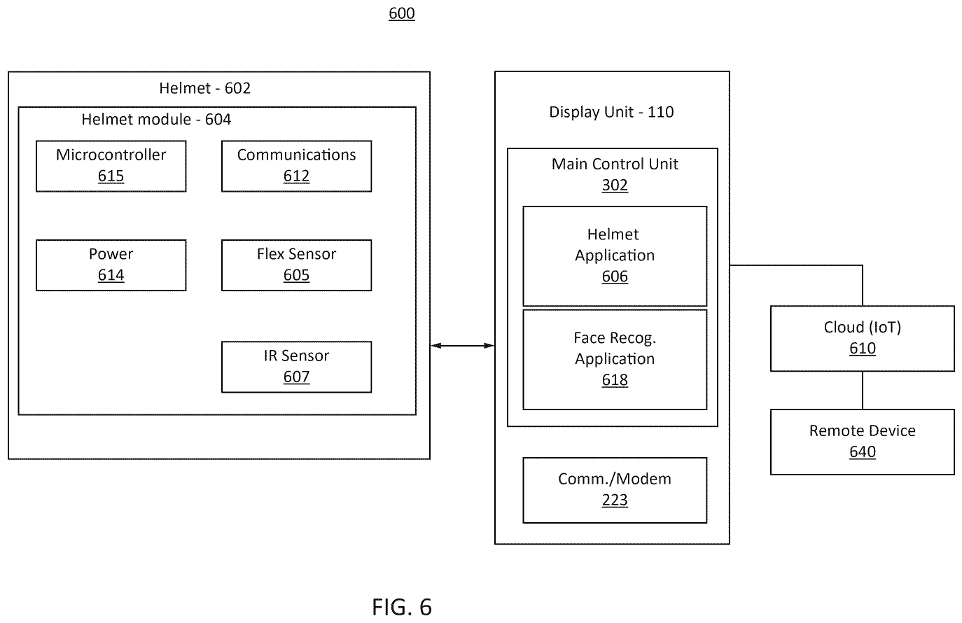

Referring to FIG. 6, in accordance with another embodiment, helmet detection system 600 is provided as a safety measure to ensure that a rider is using a helmet 602. One application 204 (FIG. 2) can include a helmet detection app 606, which can be stored in the display unit 110 or accessed through the Cloud 610. The helmet detection app 606 interlocks the helmet 602 with the e-bike 100, which can be implemented using Bluetooth™, an RF link or other communicating channel between the e-bike 100 and the helmet 602. A helmet module 604 is integrated within the helmet 602 and the helmet app 606 is stored within the display unit 110 (or Cloud 610). The helmet application 606 can communicate with the Internet of things (IoT)/Cloud 610 and can update information to and from the Cloud 610. Initially, when a bike ignition is on, a check is conducted as to whether the user is wearing the helmet 602. If the helmet 602 is not being worn, a sequence of warning messages can be displayed on the display screen 112 of the display unit 110. Remedial action can be a warning to parents or other people by sending a message (e.g., a text or email) or accessing a governmental server so that a fine can be assessed by a governmental agency. Details of helmet usage can be stored on a server via Cloud (IoT) 610. This information can also be used to disable certain functions on the e-bike 100, e.g., disable the ignition, the motor, the battery, etc.

The helmet module 604 employs sensors to determine whether the helmet is on a rider's head. In an embodiment, a flex sensor 605 and an infrared (IR) sensor 607 are employed. The helmet module 604 includes a microcontroller 615, such as an Arduino Nano™. The helmet module 604 includes a communications device 612, such as, e.g., a Bluetooth™ transmitter/receiver. The helmet module 604 includes a power supply 614. The IR sensor 607 and the flex sensor 605 are used in the detection of the helmet 602 worn by the rider. The microcontroller 615 is employed to control the components on the helmet 602. The communications device 612 is used to transmit a status to the helmet app 606 on the display unit 110. In an embodiment, a helmet detection status, an alcohol consumption status or any other status can be provided.

The main control unit 302 in the display unit 110 (or in the Cloud) receives signals from the helmet module 604 via the communications device 612 (e.g., Bluetooth™). The main control unit 302 can employ a 5G modem using a two-channel relay to send a helmet wear status via the IoT modem to the Cloud 610 or other network. In this way, the helmet status can be provided to a remote device 640 or devices parents or other individuals in accordance with permission settings.

The flex sensor 605 can include a pressure sensor mounted under a foam cushion within an interior of the helmet 602 which indicates whether the rider is wearing the helmet 602 by detecting a change in the resistance by the application of pressure while the user wears the helmet 602. The IR sensor 607 measures IR radiation across the helmet 602 to determine whether the helmet is being worn. The power supply 614 can include, e.g., a lithium battery source. The communications device 612 can include a Bluetooth™ transceiver which is used to transmit data to the main control unit 302. The main control unit 302 includes a Bluetooth™ receiver, which employs status to enable/disable functions of the e-bike 100.

In an illustrative embodiment, a rider turns the ignition 315 and a message is displayed on the display screen 112 of the display unit 110. The message can include, e.g., “Welcome, Wear your helmet”. The main control unit 302 will wait unit the helmet status changes to “worn status” by using one or more sensors, e.g., IR sensor 607 and/or flex sensor 605 to establish that the helmet is being worn. In an embodiment, the camera 316 on the display screen 112 can be employed to employ a face recognition app 618 (e.g., application 204, FIG. 2) to establish a helmet being worn on the rider and in some instance the identity of the user (e.g., ensure the owner is the user/rider). The status changing to “worn” permits the main control unit 302 to enable the ignition to permit the battery 310 and/or the motor 142 to be enabled for use. At any point during operation, if the helmet 602 is removed the main control unit 302 can disable functions, e.g., disable the battery 310 using switch 313, disable the motor 142 (e.g., by disengaging the chain 124), enable a visual (e.g., a warning message on the display screen 112), audible warning (“Replace your helmet” uttered through the speaker 218), etc.

The integrated modem of the communications device 223 can be employed to provide the helmet worn status to a remote person (e.g., a parent). The modem can send a text message, email or even phone call. The helmet worn status can be stored within a data storage location on the display unit 110 or in the Cloud 610/on a server. A report or helmet status can be downloaded or delivered depending on permission and user settings.

Embodiments of the present invention include e-bikes having computer systems, methods, and/or stored computer programs at any level of integration. The computer programs may include a computer program product having a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium is non-transitory and may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments for an e-bike (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. An electric bicycle, comprising:
a frame;
a battery mounted on the frame;
a motor powered by the battery to move the electric bicycle;
handlebars rotatably coupled to the frame to steer the electric bicycle; and
a display unit mounted on the handlebars and powered by the battery, the display unit including:
a processor;
a display coupled to the processor;
memory coupled to the processor; and
a communications device including a modem coupled to the processor, the modem to communicate a status of the electric bicycle to a cellular network.

2. The electric bicycle as recited in claim 1, wherein the display unit includes a main control unit that automatically disables a function of the electric bicycle in accordance with violation of a stored permission.

3. The electric bicycle as recited in claim 2, wherein the function includes a measured speed of the electric bicycle and the stored permission includes exceeding a speed threshold.

4. The electric bicycle as recited in claim 2, wherein the function includes a measured distance of the electric bicycle and the stored permission includes exceeding a distance threshold.

5. The electric bicycle as recited in claim 2, wherein the function includes a measured boundary of the electric bicycle and the stored permission includes exceeding a boundary threshold.

6. The electric bicycle as recited in claim 2, wherein the main control unit disables the battery.

7. The electric bicycle as recited in claim 2, wherein the main control unit messages a remote person to provide a warning of the violation.

8. The electric bicycle as recited in claim 1, further comprising a radar mounted on the frame to warn of approaching objects.

9. The electric bicycle as recited in claim 1, further comprising:
a camera mounted on the display unit; and
an application for face recognition to identify a rider.

10. The electric bicycle as recited in claim 9, further comprising:
a mechanism to disable a function of the electric bicycle if the rider lacks permission in accordance with the application for face recognition.

11. The electric bicycle as recited in claim 1, wherein the status includes a helmet worn status indicating whether a rider is wearing a helmet.

12. The electric bicycle as recited in claim 1, further comprising one or more cameras integrated on the electric bicycle to capture images of approaching objects.

13. The electric bicycle as recited in claim 12, further comprising an application to identify the approaching objects.

14. An electric bicycle, comprising:
a frame;
a battery mounted on the frame;
a motor powered by the battery to move the electric bicycle;
handlebars rotatably coupled to the frame to steer the electric bicycle; and
a display unit mounted on the handlebars and powered by the battery, the display unit including:
a processor;
a display coupled to the processor;
memory coupled to the processor; and
a helmet application communicating with a helmet module to determine a status of a helmet being worm by a user.

15. The electric bicycle as recited in claim 14, wherein the display unit includes a main control unit that automatically disables a function of the electric bicycle in accordance with violation of a stored permission.

16. The electric bicycle as recited in claim 15, wherein the function includes a measured speed of the electric bicycle and the stored permission includes exceeding a speed threshold.

17. The electric bicycle as recited in claim 15, wherein the function includes a measured distance of the electric bicycle and the stored permission includes exceeding a distance threshold.

18. The electric bicycle as recited in claim 15, wherein the function includes a measured boundary of the electric bicycle and the stored permission includes exceeding a boundary threshold.

19. The electric bicycle as recited in claim 15, wherein the main control unit disables the battery.

20. The electric bicycle as recited in claim 15, wherein the main control unit messages a remote person to provide a warning of the violation.

21. The electric bicycle as recited in claim 14, further comprising a radar mounted on the frame to warn of approaching objects.

22. The electric bicycle as recited in claim 14, further comprising a helmet including a sensor to determine a helmet worn status indicating whether the user is wearing a helmet; and a communications device to transit the status to the display unit.

23. The electric bicycle as recited in claim 14, further comprising:
a camera mounted on the display unit; and
an application for face recognition to identify a helmet on the user.

24. The electric bicycle as recited in claim 14, further comprising a communications device including a modem coupled to the processor, the modem to communicate a helmet worn status to a cellular network.

25. The electric bicycle as recited in claim 14, further comprising:
a mechanism to disable a function of the electric bicycle if the user lacks permission in accordance with an application for face recognition that identifies the user.

26. The electric bicycle as recited in claim 14, further comprising one or more cameras integrated on the electric bicycle to capture images of approaching objects.

27. The electric bicycle as recited in claim 26, further comprising an application to identify the approaching objects.
